(19) United States
(12) Patent Application Publication
(10) Pub. No.: US 2015/0077518 A1
(43) Pub. Date: Mar. 19, 2015

(54) APPARATUS FOR MOBILE PATTERN PROJECTION

(71) Applicant: SIEMENS AKTIENGESELLSCHAFT, München (DE)

(72) Inventors: Wolfgang Heine, Unterhaching (DE); Patrick Wissmann, Munich (DE)

(73) Assignee: SIEMENS AKTIENGESELLSCHAFT, München (DE)

(21) Appl. No.: 14/390,005

(22) PCT Filed: Jun. 3, 2013
(86) PCT No.: PCT/EP2013/061394

§ 371 Date: Oct. 1, 2014

(30) Foreign Application Priority Data
Jun. 26, 2012 (DE) 2012 210 872.6

(51) Int. Cl. H04N 13/02

(52) U.S. Cl. CPC H04N 13/0296; H04N 13/0257
USPC 348/46

(57) ABSTRACT

Integration of an apparatus for recording a three-dimensional image of a measurement object in mobile computer apparatuses provides additional functions. The integration can be very cost-effective and simple. Smartphones, tablet computers and personal digital assistants can be used for such image capture.

### CROSS REFERENCE TO RELATED APPLICATIONS

This application is the U.S. national stage of International Application No. PCT/EP2013/061394, filed Jun. 3, 2013 and claims the benefit thereof. The International Application claims the benefit of German Application No. 102012210872.6 filed on Jun. 26, 2012, both applications are incorporated by reference herein in their entirety.

### BACKGROUND

Described below are apparatuses and uses for recording a three-dimensional image of a measurement object having a surface according to the active triangulation principle, using a projector device for projecting a light pattern from a first perspective onto the measurement object, at least one camera device which records from at least one further perspective synchronously with the projector device, for the synchronous recording of the measurement object together with the light pattern, and a computer device for the calculation of spatial coordinates mapping the surface of the object, the calculation being performed based on the synchronous recording.

DE 41 15 445 A1 discloses a method for recording a three-dimensional image of an object according to the active triangulation principle, using a video camera, which has an image storage device, and a laser projector, which has an optical unit and a coding and storage device, which projects onto the object a code for object marking in the form of light section planes with a predefined frequency, wherein the projector is synchronized with the video camera, which records the object markings during the recording of the object.

US 2002/0162886 A1 discloses a system for three-dimensional scanning that uses an apparatus for three-dimensional scanning, which is manually maneuverable and has a profilometer with a light beam projector, an objective lens and a light detector.

The method of active triangulation is increasingly being used to realize mobile, hand-held 3D measuring devices. Image recordings may be communicated to an external data processing unit and converted into 3D data sets by the latter. Appliances which operate with a stationary camera and a hand-held device for pattern projection are likewise known.

Conventional solutions are associated with relatively high costs. Conventional embodiments are bulky, heavy and wired.

The problem addressed by the apparatus and method is providing simple, cost-effective, compact and mobile acquisition of spatial coordinates mapping a surface of a measurement object.

A first aspect involves an apparatus for recording a three-dimensional image of a measurement object having a surface according to the active triangulation principle, having the following component parts. A projector device for projecting a light pattern from a first perspective onto the measurement object. At least one camera device which records from at least one further perspective synchronously with the projector device, for the synchronous recording of the measurement object together with the light pattern. A computer device for the calculation of spatial coordinates mapping the surface of the object, the calculation being performed based on the synchronous recording. The apparatus is distinguished by the fact that a mobile computer device is used which provides additional functions over and above the provision of the three-dimensional image.

Apparatuses and methods described below make it possible to utilize portable minicomputers additionally as three-dimensional optical measuring devices according to the method of active triangulation.

### SUMMARY

In accordance with one advantageous configuration, the mobile computer apparatus which provides additional functions over and above the three-dimensional image recording can be a cellphone, a personal digital assistant, a tablet personal computer or a music player. In principle, known minicomputers are encompassed by such computer apparatuses. By way of example, so-called “smartphones” are likewise encompassed.

In accordance with a further advantageous configuration, the camera device and the computer device can be camera and computer of the mobile computer apparatus.

In accordance with a further advantageous configuration, the projector device can be fixed to the mobile computer apparatus outside the latter.

In accordance with a further advantageous configuration, the projector device can have, in front of a flash illumination unit integrated into the mobile computer apparatus, along the optical axis of the flash illumination unit, an optical unit which shapes a beam and an optical unit which images the beam onto the measurement object.

In accordance with a further advantageous configuration, the projector device can have a dedicated illumination device, an optical unit which shapes a beam and an optical unit which images the beam onto the measurement object.

In accordance with a further advantageous configuration, the projector device can be completely integrated into the mobile computer device.

In accordance with a further advantageous configuration, the optical unit which shapes the beam can be a homogeneously illuminated pattern transparency.

In accordance with a further advantageous configuration, the projector device can be supplied with electrical power by the computer apparatus.

In accordance with a further advantageous configuration, the computer apparatus can be a portable minicomputer which provides functions in addition to the three-dimensional image recording. Such additional functions can enable, for example, communication, music or any other applications.

In accordance with a further advantageous configuration, an apparatus can be used, for example, for nondestructively testing the measurement object, for reverse engineering or for consumer electronics.

### BRIEF DESCRIPTION OF THE DRAWINGS

These and other aspects and advantages will become more apparent and more readily appreciated from the following description of exemplary embodiments, taken in conjunction with the accompanying drawings of which:

FIG. 1A is a schematic perspective view depicting a known exemplary embodiment of a method;

FIG. 1B is a perspective view of a human head;

FIGS. 2A to 2E illustrate a first exemplary embodiment of an apparatus in which:
FIG. 2A is a front view,
FIG. 2B is a partial rear view,
FIG. 2C is a partial rear view with a projector device added,
FIG. 2D is a schematic side view, and
FIG. 2E is a front view with a projected light pattern;

FIGS. 3A to 3D illustrate a second exemplary embodiment of the apparatus in which:
FIG. 3A is a front view,
FIG. 3B is a rear view,
FIG. 3C is a schematic side view, and
FIG. 3D is a front view with a projected light pattern;

FIG. 4 is a front view of a further exemplary embodiment of the apparatus;

FIGS. 5A to 5F are exemplary embodiments of measurement patterns; and

FIG. 6 is a block diagram of various uses of the apparatus.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

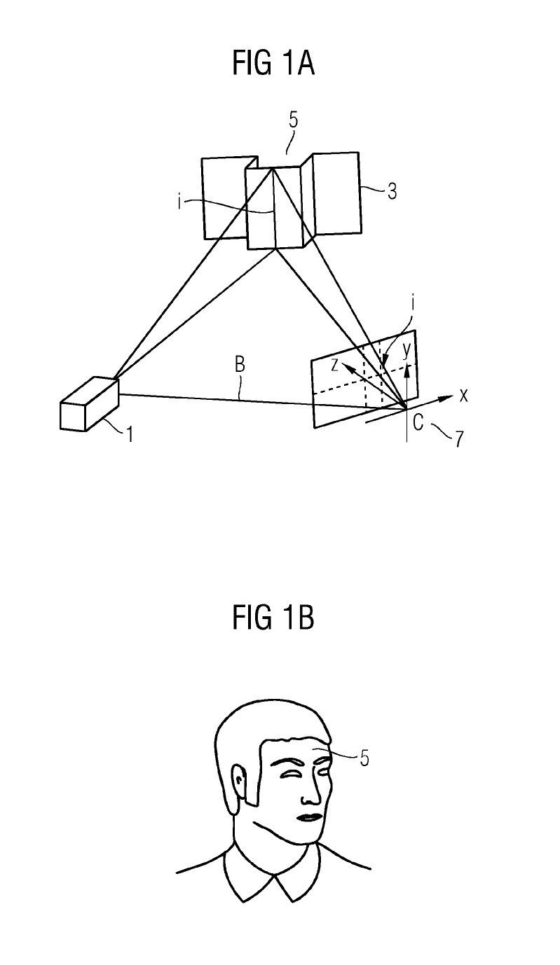

The known method of active triangulation uses a projector device 1 for projecting a light pattern, which can be characterized for example by a stripe index i. Light patterns can be generated, for example, as a laser line, a stripe pattern or a color pattern. FIG. 1A shows a stripe pattern as light pattern 3. FIG. 1A shows a black and white representation of a color-coded measurement pattern that has been projected onto a measurement object 5. In addition, the light pattern 3 is recorded synchronously by one or a plurality of cameras 7 from a different perspective. If the pattern 3 projected onto the measurement object 5 can be identified in the camera image, that is to say can be assigned to its origin in the pattern projector 1, coordinates in space which represent the surface of the measurement object 5 can be calculated by a computer device 9 with the aid of the two lines of sight of camera 7 and projector 1. FIG. 1A shows a required triangulation basis with the reference sign B between the projector arrangement 1 and the camera device 7. FIG. 1B shows one exemplary embodiment of a 3D model—assembled from a plurality of measurements—of a human face as an example of a measurement object 5.

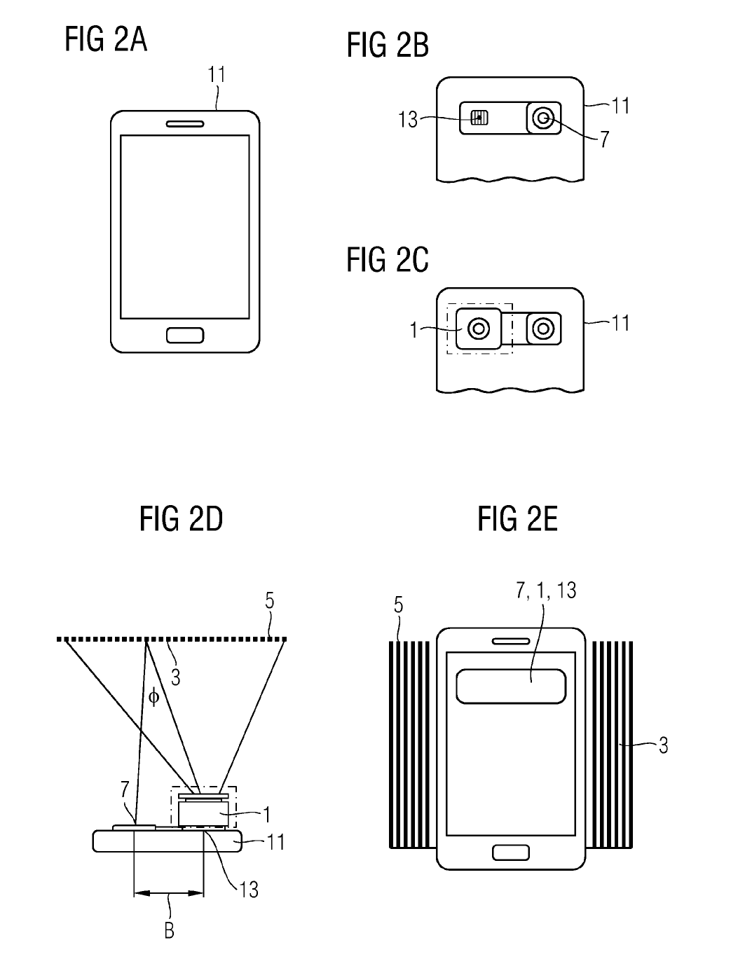

FIGS. 2A to 2E show a first exemplary embodiment of an apparatus. In accordance with this exemplary embodiment, a projector device 1 is fixed to a mobile computer apparatus 11 on the outside thereof. In accordance with this exemplary embodiment, the mobile computer apparatus 11 which provides functions over and above the three-dimensional image recording is a cellphone, in particular a so-called smartphone. FIG. 2A shows a front view of the mobile computer apparatus 11 which provides additional functions. In principle, such computer apparatuses can be minicomputers which enable any desired functions. FIGS. 2B and 2C show respective views of the rear side of the computer apparatus 11. FIG. 2B shows, on a right-hand side, a camera device 7 integrated into the computer apparatus 11 and, on a left-hand side alongside that, a flash illumination unit 13 already integrated into the computer apparatus 11. The flash illumination unit 13 is conventionally used for the exposure of a measurement object 5. FIG. 2C shows a projector device 1 fixed to the mobile computer apparatus 11 on the outside thereof. The projector device 1 uses a camera flash, such that the projector device can be designated as flash projector supplement. In accordance with FIG. 2C, the projector device 1 is arranged in front of the flash illumination unit 13 integrated into the mobile computer apparatus 11, and may be fixed there. FIG. 2D shows the view in accordance with FIG. 2C from above. The mobile computer apparatus 11 uses the camera device 7 and the flash illumination unit 13 for performing a three-dimensional image recording. The projector device 1 is arranged in front of the flash illumination unit 13 integrated into the mobile computer apparatus 11. The projector device 1 has, along the optical axis of the flash illumination unit 13, an optical unit which shapes a beam and an optical unit which images the beam onto the measurement object 5. FIG. 2D shows a light pattern 3 which is projected onto a planar measurement object 5. The angle φ represents the angle between a light pattern beam and a viewing beam of the camera device 7. Furthermore, the reference sign B designates a triangulation baseline. FIG. 2E shows once again the front view in accordance with FIG. 2A additionally with the light pattern 3 projected by way of example and with an illustration of a combination of camera device 7 and projector device 1 using the flash illumination unit 13 already originally integrated into the mobile computer apparatus 11. FIGS. 2A to 2E show a first exemplary embodiment using a factory-integrated photographic flash for the projection of measurement patterns for the purpose of active triangulation. FIG. 2A shows by way of example a portable minicomputer in the form of a personal digital assistant (PDA) or smartphone. FIG. 2B shows an increasingly factory-integrated combination having a camera device 7 and a photographic flash illumination unit 13. FIG. 2C shows one possible embodiment of a projector device 1 for projecting a measuring light pattern 3 with the aid of an integrated flash illumination unit 13. FIG. 2D shows by way of example a projected measuring light pattern 3 which is reflected on the surface of the object 5 to be measured and is recorded by an integrated camera device 7. Light pattern 3 is configured in such a way that after an image recording it is possible to establish a correspondence between a plurality of camera pixels and a plurality of stripes or points in the measurement pattern. A geometrical intersection of in each case two corresponding lines of sight from the camera device 7 and the projector device 1 has the result of obtaining a surface point in a three-dimensional coordinate system. This corresponds to the conventional method of active triangulation. A multiplicity of geometrical intersections results in an approximate 3D representation of the surface to be measured of the measurement object 5. FIG. 2E shows the illustration in accordance with FIG. 2D from a different perspective.

FIGS. 2A to 2E show one exemplary embodiment of a modern portable minicomputer. Smartphones, personal digital assistants or tablet computers have with increasing prevalence a factory-integrated camera device 7. The most recent appliances additionally have an integrated photographic flash illumination unit 13. This flash illumination unit 13 can be used as a light source for a pattern projection with the aim of structured illumination and triangulation. For this purpose, use is made of a beam shaping device which uses a corresponding pattern transparency illuminated homogeneously. In principle, corresponding pattern stencils can be used. The transparency through which radiation is transmitted or the stencil through which radiation is transmitted is in turn projected onto the object 5 to be measured by an imaging optical unit. The beam shaping part and the imaging part of the optical unit can be integrated in a common projector device 1, fitted along the optical axis of the flash illumination unit 13. An integrated camera device 7 in conjunction with the projector device 1 makes it possible to use mobile computer apparatuses 11 which provide additional functions additionally as three-dimensional measuring instruments. Such 3D acquisition devices can be used, for example, for a nondestructive testing technique for testing the measurement object 5.

FIGS. 2A to 2E illustrate an embodiment which, by beam shaping and homogenization, illuminates a pattern suitable for active triangulation, in particular in the form of a pattern transparency, with light from a flash illumination unit 13 originally used for taking photographs. Such photographic flash illumination units 13 are increasingly being integrated in modern portable minicomputers, such as, for example, smartphones, personal digital assistants or tablet PCs. Projector device 1 furthermore contains an optical unit for projecting the pattern transparency onto an object 5 to be measured. In conjunction with a camera device 7 integrated in the portable minicomputer, the apparatus can additionally be used for three-dimensional optical measurement.

The alternative use of existing conventional components and of an adapted external projector device 1 affords the following advantages. Cost-effective, compact, light and wireless embodiments can be provided. Integration into conventional mobile computer apparatuses can easily be implemented since the integrated data processing power provided by the mobile computer apparatus is sufficient for processing 3D scans. Therefore, no further additional personal computer hardware is required. In addition, 3D data can be implemented in a simple manner using wireless data communication, for example WLAN or Bluetooth or memory cards.

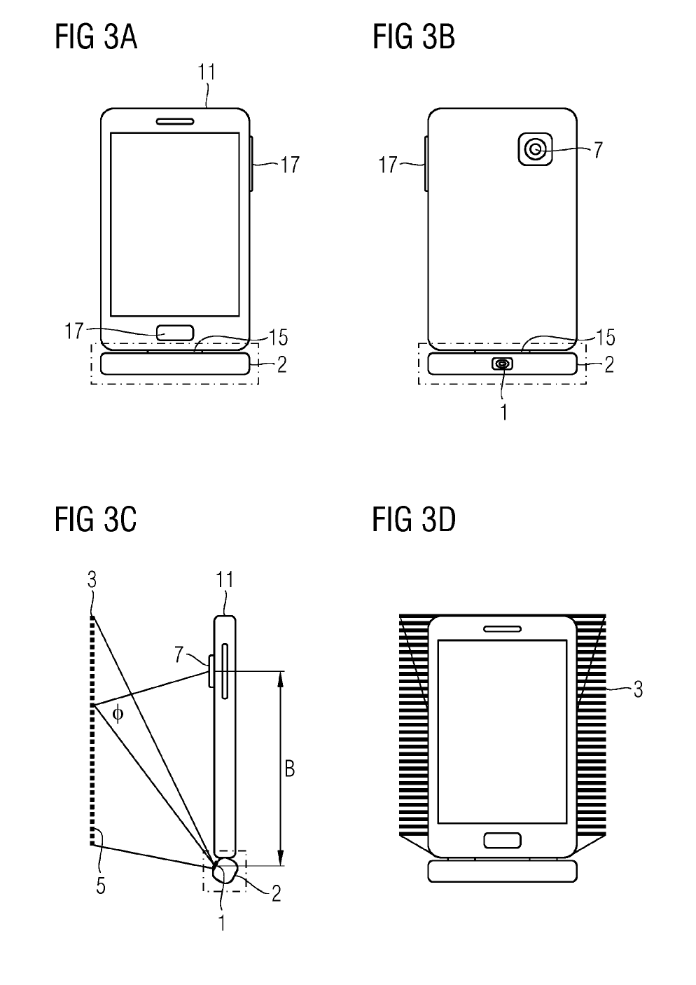

FIGS. 3A to 3D show a second exemplary embodiment of the apparatus. In accordance with FIGS. 3A to 3D, as mobile minicomputer a smartphone is proposed as mobile computer apparatus 11. FIG. 3A shows a front view of the mobile computer apparatus 11 which provides additional functions, wherein the projector device 1 is fixed to the mobile computer apparatus 11 on the outside thereof. The projector device 1 here has a dedicated illumination device, an optical unit which shapes a beam and an optical unit which images the beam onto the measurement object. The projector device 1 can be part of a projector unit which is mechanically coupled to the mobile computer apparatus 11. The projector unit can be fixed to the mobile computer apparatus 11 in a mechanically releasable manner, for example. In addition, the projector unit can be arranged in a pivotable manner. Reference sign 15 designates a corresponding fixing device. Hardware operating elements are identified by the reference sign 17. FIG. 3B shows a view from the rear side of the illustration in accordance with FIG. 3A. A camera device 7 can be combined with an external projector device 1. FIG. 3C shows a side view, wherein projector device 1 is mechanically coupled to the mobile computer apparatus 11 by projector unit 2 and projects an exemplary light pattern 3 onto the surface of a measurement object 5. The spatial arrangement of a camera device 7 with respect to the projector device 1 defines the baseline B required for a triangulation. The angle φ is defined by the path of a pattern beam with respect to a viewing beam. FIG. 3D shows once again a front view additionally with the projected light pattern 3. FIGS. 3A to 3D show a projector device 1 integrated into a projector unit 2 which is mechanically coupled to the mobile computer apparatus 11 in a rotatable manner. Particularly advantageously, the projector unit 2 can be directly supplied with electrical power by the mobile computer apparatus 11. FIGS. 3A to 3D show an external projector unit 2, which has accommodated a projector device 1, for projecting a light pattern 3 as measurement pattern for the purpose of active triangulation. FIGS. 3A and 3B show by way of example a portable minicomputer in the form of a smartphone or a personal digital assistant of a fitted external projector unit 2 for projecting a light pattern 3. FIGS. 3C and 3D show by way of example a projected measurement pattern which is reflected on the surface of the measurement object 5 to be measured and is recorded by a camera device 7 integrated into the mobile computer apparatus 11. In connection with FIGS. 3C and 3D, reference is additionally made to the description of FIG. 2D. In contrast to FIGS. 2A to 2E, in the case of which an integrated photographic flash illumination unit is used as a light source for a pattern projection with the aim of structured illumination, the pattern projection is now effected by an external projector unit 2. In accordance with this embodiment, an external projector unit 2 for pattern projection is fitted to the mobile computer apparatus 11. In this case, such a projector unit 2 can be embodied in a very compact fashion. In addition, such a projector unit 2 can be supplied with electrical power by the mobile computer apparatus, thus resulting in the portability and wireless nature of the apparatus. The exemplary embodiment in accordance with FIGS. 3A to 3D shows an apparatus with a projector unit 2 for projecting a pattern suitable for active triangulation, which provides a possibility for mounting onto the portable minicomputer and enables, if appropriate, power supply by the latter. A 3D measuring apparatus which can perform a method of active triangulation arises in combination.

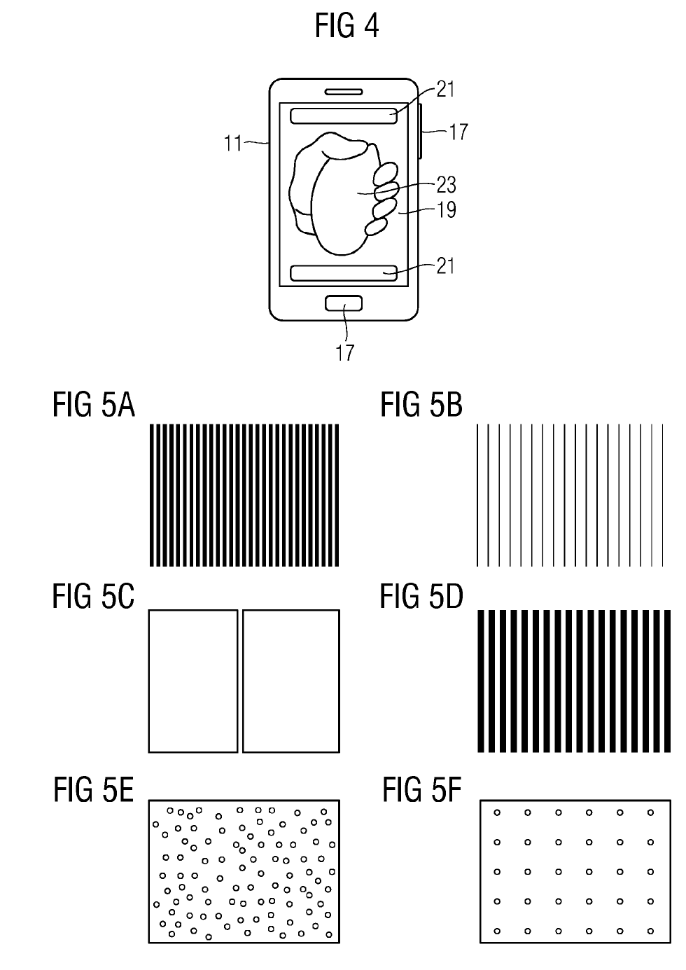

FIG. 4 shows a further exemplary embodiment of the apparatus. FIG. 4 shows a smartphone as an example of a mobile computer apparatus. This front view shows hardware actuation elements 17 and a touch-sensitive display Reference sign 21 identifies operating elements that are only provided in terms of software. These are, in particular, so-called icons for switching procedures which are performed by the mobile computer apparatus 11. Reference sign 23 represents an interactive 3D preview of a measurement object 5. FIG. 4 shows one exemplary embodiment using integration of a 3D measuring apparatus into a mobile minicomputer. Conventional user interfaces can be used simply and effectively for an interactive representation and control of 3D measuring processes. In accordance with FIG. 4, already integrated devices of mobile computer apparatuses 11 are used for projecting measuring light patterns 3. Correspondingly, an embodiment in accordance with FIG. 4 uses projectors already factory-integrated into corresponding mobile computer apparatuses. The projectors integrated for media representation, for example for representing photographs or films, can be used for pattern projection for the purpose of active triangulation, as a result of which 3D measurements are made possible in a simple manner merely by software developments. Correspondingly, in accordance with FIG. 4, a projector device 1 required for the active triangulation is completely integrated in a known mobile computer apparatus 11 already available. Projection devices or projector devices 1 factory-integrated into portable minicomputers in conjunction with a factory-integrated camera or camera device 7 are used for 3D measurement according to the method of active triangulation. This use of the combination of existing components in conjunction with the methods of active triangulation brings about an additional benefit, that is to say the obtaining of 3D measurement data. No additional apparatuses are required. An implementation can be effected in terms of software in a simple manner. Complete integration is particularly advantageous in particular with regard to reduced costs. FIG. 4 shows how an integrated screen, that is to say a so-called touchscreen, can be used, if appropriate, for an interactive visualization of measurement results or for navigating a 3D model.

FIGS. 5A to 5F show exemplary embodiments of patterns suitable as measurement patterns for recording three-dimensional images. Such patterns can be projected by the apparatus. These light patterns 3 are already known in the related art.

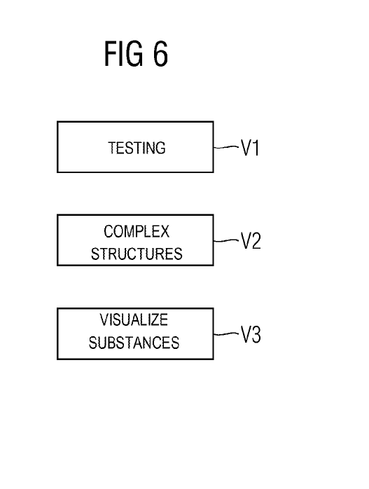

FIG. 6 illustrates various uses Vx of THE apparatus. The 3D measuring instruments resulting from the apparatuses and corresponding methods are essentially distinguished by a very high cost-effectiveness and mobility. Possible areas of application are found, inter alia, in the fields of nondestructive testing technology, for example for quality controls or inspections, reverse engineering and, for example, consumer electronics. Combination of a plurality of 3D recordings, this corresponding to a video mode, with additional sensor systems for location determination and position changes makes it possible to acquire even complex spatial structures. By combining the 3D acquisition with a 2D image recording performed by either an internal camera or an external camera, it is possible to map the 2D image contents onto the 3D surface of the object. This method makes it possible, for example, by suitable illumination, for example by ultraviolet light, to visualize fluorescent or other substances on the surface of the object and to assign the positions of the substances to the object in a localized manner.

Described above is simple integration of an apparatus for recording a three-dimensional image of a measurement object 5 into mobile computer apparatuses 11 which provide functions in addition thereto. Such integration can be implemented very cost-effectively and simply. In this way, in particular, smartphones, tablet computers and personal digital assistants can additionally be used for such image acquisition.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-11. (canceled)

12. An apparatus for recording a three-dimensional image of a surface of a measurement object having a surface, according to an active triangulation principle, comprising:
a mobile computer apparatus providing other functions in addition to the recording of the three-dimensional image of the measurement object, including
a projector device projecting a light pattern from a first perspective onto the measurement object;
at least one camera device recording, from at least one second perspective different from the first perspective, a detected image of the measurement object with the light pattern projected thereon, synchronously with the projecting by the projector device;
a computer device calculating spatial coordinates mapping the surface of the measurement object based the recording of the detected image.

13. The apparatus as claimed in claim 12, wherein the mobile computer apparatus is at least one of a cell phone, a personal digital assistant, a tablet personal computer and a music player.

14. The apparatus as claimed in claim 13, wherein the at least one camera device and the computer device are disposed inside an external cover of the mobile computer apparatus.

15. The apparatus as claimed in claim 14, wherein the projector device is attached to the external cover of the mobile computer apparatus.

16. The apparatus as claimed in claim 15,
wherein the mobile computer apparatus includes a flash illumination unit disposed inside the external cover of the mobile computer apparatus, and
wherein the projector device comprises an optical unit disposed in front of and along an optical axis of the flash illumination unit of the mobile computer apparatus, including
a beam shaping part shaping a beam output by the flash illumination unit; and
an imaging part projecting the beam onto the measurement object.

17. The apparatus as claimed in claim 16, wherein the beam shaping optical unit is a homogeneously illuminated pattern transparency.

18. The apparatus as claimed in claim 15, wherein the projector device comprises:
a dedicated illumination device;
a beam shaping optical unit shaping a beam; and
an imaging optical unit projecting the beam onto the measurement object.

19. The apparatus as claimed in claim 18, wherein the beam shaping optical unit is a homogeneously illuminated pattern transparency.

20. The apparatus as claimed in claim 18, wherein the mobile computer apparatus further includes a power supply, disposed inside the external cover of the mobile computer apparatus, supplying electrical power to the projector device.

21. The apparatus as claimed in claim 20, wherein the mobile computer apparatus is a portable minicomputer.

22. The apparatus as claimed in claim 14, wherein the projector device is completely integrated into the mobile computer apparatus.

23. The apparatus as claimed in claim 12, wherein the at least one camera device and the computer device are disposed inside an external cover of the mobile computer apparatus.

24. The apparatus as claimed in claim 23, wherein the projector device is attached to the external cover of the mobile computer apparatus.

25. The apparatus as claimed in claim 24,
wherein the mobile computer apparatus includes a flash illumination unit disposed inside the external cover of the mobile computer apparatus, and
wherein the projector device comprises an optical unit disposed in front of and along an optical axis of the flash illumination unit of the mobile computer apparatus, including
beam shaping part shaping a beam output by the flash illumination unit; and
an imaging part projecting the beam onto the measurement object.

26. The apparatus as claimed in claim 25, wherein the beam shaping optical unit is a homogeneously illuminated pattern transparency.

27. The apparatus as claimed in claim 24, wherein the projector device comprises:
a dedicated illumination device;
a beam shaping optical unit shaping a beam; and
an imaging optical unit projecting the beam onto the measurement object.

28. The apparatus as claimed in claim 27, wherein the beam shaping optical unit is a homogeneously illuminated pattern transparency.

29. The apparatus as claimed in claim 27, wherein the mobile computer apparatus further includes a power supply, disposed inside the external cover of the mobile computer apparatus, supplying electrical power to the projector device.

30. The apparatus as claimed in claim 29, wherein the mobile computer apparatus is a portable minicomputer.

31. The apparatus as claimed in claim 23, wherein the projector device is completely integrated into the mobile computer apparatus.

32. The apparatus as claimed in claim 12, wherein the computer device further performs at least one of nondestructive testing and reverse engineering of the measurement object based on the spatial coordinates mapping the surface of the measurement object.
